(19) United States
(12) Patent Application Publication
(10) Pub. No.: US 2018/0101445 A1
(43) Pub. Date: Apr. 12, 2018

(54) INFORMATION PROCESSING APPARATUS AND INFORMATION PROCESSING METHOD

(71) Applicant: FUJITSU LIMITED, Kawasaki-shi (JP)

(72) Inventor: Takashi Imai, Atsugi (JP)

(73) Assignee: FUJITSU LIMITED, Kawasaki-shi (JP)

(21) Appl. No.: 15/697,593

(22) Filed: Sep. 7, 2017

(30) Foreign Application Priority Data
Oct. 6, 2016 (JP) 2016-198485

(51) Int. Cl. G06F 11/14; G06F 11/20; H04L 12/40

(52) U.S. Cl. CPC G06F 11/1425; H04L 43/0817; H04L 12/40; G06F 11/2094

(57) ABSTRACT

An information processing apparatus includes a memory and a processor coupled to the memory. The processor is configured to determine, when a simultaneous distribution is made to a plurality of destinations, whether a first communication situation in the information processing apparatus is worse than a predetermined reference. The processor is configured to select a request destination from among the plurality of destinations upon determining that the first communication situation is worse than the predetermined reference. The processor is configured to request the request destination to perform the simultaneous distribution to part of the plurality of destinations except for the request destination.

### CROSS-REFERENCE TO RELATED APPLICATION

This application is based upon and claims the benefit of priority of the prior Japanese Patent Application No. 2016-198485, filed on Oct. 6, 2016, the entire contents of which are incorporated herein by reference.

### FIELD

The embodiments discussed herein are related to an information processing apparatus and an information processing method.

### BACKGROUND

An information processing system, which includes a plurality of wireless terminals communicating with each other through, for example, a wireless local area network (LAN), and uses a peer-to-peer technology, does not require a server device. Accordingly, there is an advantage in that a construction cost is low.

In such an information processing system, since a server device is not provided, shared data is often held by the plurality of wireless terminals. Therefore, data may be simultaneously distributed from a transmission origin to respective destinations.

In the case of using a wireless LAN, communications are difficult to be stabilized compared to the case of using a wired communication network.

Related technologies are disclosed in, for example, Japanese Laid-Open Patent Publication No. 2001-216282 and Japanese Laid-Open Patent Publication No. 2014-197266.

### SUMMARY

According to an aspect of the present invention, provided is an information processing apparatus including a memory and a processor coupled to the memory. The processor is configured to determine, when a simultaneous distribution is made to a plurality of destinations, whether a first communication situation in the information processing apparatus is worse than a predetermined reference. The processor is configured to select a request destination from among the plurality of destinations upon determining that the first communication situation is worse than the predetermined reference. The processor is configured to request the request destination to perform the simultaneous distribution to part of the plurality of destinations except for the request destination.

The object and advantages of the disclosure will be realized and attained by means of the elements and combinations particularly pointed out in the claims. It is to be understood that both the foregoing general description and the following detailed description are exemplary and explanatory and are not restrictive of the disclosure, as claimed.

### BRIEF DESCRIPTION OF DRAWINGS

FIG. 1 is a diagram illustrating an exemplary configuration of a network;

FIG. 2 is a diagram illustrating an example of a simultaneous distribution performed by a wireless terminal as a transmission origin;

FIG. 3 is a diagram illustrating an example of a simultaneous distribution performed by a proxy wireless terminal;

FIG. 4 is a diagram illustrating an example of a simultaneous distribution performed by a proxy wireless terminal;

FIG. 5 is a diagram illustrating an exemplary functional configuration of a wireless terminal;

FIG. 6 is a diagram illustrating an example of a member table;

FIG. 7 is a diagram illustrating an example of a throughput table;

FIG. 8 is a diagram illustrating an exemplary functional configuration of a throughput collector;

FIG. 9 is a sequence diagram illustrating an exemplary sequence of notifying of throughput in a wireless section;

FIG. 10 is a diagram illustrating an exemplary functional configuration of a controller;

FIG. 11A is a flowchart illustrating a flow of a main process (A);

FIG. 11B is a flowchart illustrating a flow of the main process (A);

FIG. 12 is a flowchart illustrating a flow of a candidate extraction process (A);

FIG. 13 is a flowchart illustrating a flow of a determination process (A);

FIG. 14 is a flowchart illustrating a flow of a proxy process;

FIG. 15 is a diagram illustrating an exemplary functional configuration of a response time collector;

FIG. 16 is a sequence diagram illustrating an exemplary sequence of determining a minimum value of response times;

FIG. 17 is a diagram illustrating an example of a first time table;

FIG. 18 is a diagram illustrating an example of a second time table;

FIG. 19 is a sequence diagram illustrating an exemplary sequence of notifying of a minimum value of response times;

FIG. 20 is a flowchart illustrating a flow of a main process (B);

FIG. 21 is a flowchart illustrating a flow of a candidate extraction process (B);

FIG. 22 is a flowchart illustrating a flow of a determination process (B);

FIG. 23 is a flowchart illustrating a flow of a determination process (C);

FIG. 24 is a diagram illustrating an exemplary configuration of a network;

FIG. 25 is a diagram illustrating an exemplary configuration of a network;

FIG. 26 is a diagram illustrating an example of a member table according to a fourth embodiment;

FIG. 27A is a flowchart illustrating a flow of a main process (C);

FIG. 27B is a flowchart illustrating a flow of a main process (C);

FIG. 28 is a flowchart illustrating a flow of a candidate extraction process (C);

FIG. 29 is a flowchart illustrating a flow of a main process (D);

FIG. 30 is a flowchart illustrating a flow of a candidate extraction process (D); and

FIG. 31 is a diagram illustrating an exemplary hardware configuration of a computer.

### DESCRIPTION OF EMBODIMENTS

### First Embodiment

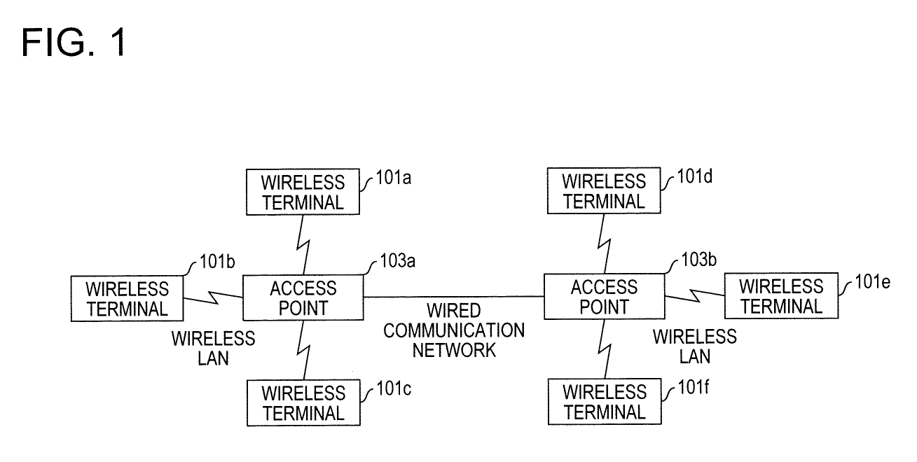

FIG. 1 illustrates an exemplary configuration of a network. A wireless terminal 101 is coupled to an access point 103 using a wireless LAN. In this example, each of wireless terminals 101a to 101c is coupled to an access point 103a. Each of wireless terminals 101d to 101f is coupled to an access point 103b.

The access point 103a and the access point 103b are coupled to each other via a wired communication network. The wired communication network is, for example, a wired LAN or the Internet. When the access point 103a and the access point 103b are coupled to each other via a wired LAN, for example, each of the access point 103a and the access point 103b is coupled to Ethernet (registered trademark). When the access point 103a and the access point 103b are coupled to each other via the Internet, each of the access point 103a and the access point 103b is coupled to the Internet via, for example, a broadband router and an Internet connection device. Each access point 103 may be a device (e.g., a wireless broadband router) having functions of an access point and a broadband router. In this case, the device is coupled to the Internet via an Internet connection device.

It is assumed that each wireless terminal 101 has a function of sending data to other wireless terminals 101 via a wireless LAN or via a wireless LAN and a wired communication network.

In this example, it is assumed that in order to share data by the wireless terminals 101, data held by a wireless terminal 101 as a transmission origin is distributed to other wireless terminals 101. Hereinafter, descriptions will be made of an example in which data held by the wireless terminal 101b is distributed to each of the wireless terminal 101a and the wireless terminals 101c to 101f.

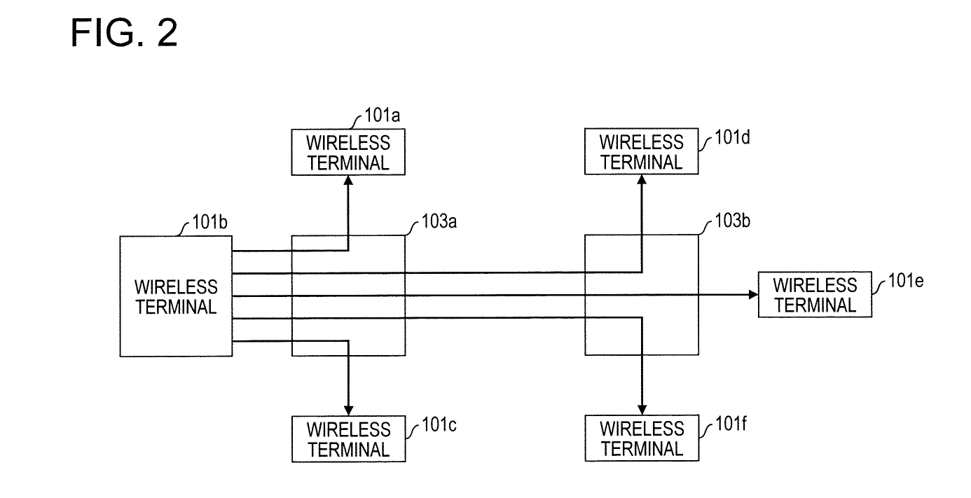

FIG. 2 illustrates an example of a simultaneous distribution performed by the wireless terminal 101b as a transmission origin. In this example, from the wireless terminal 101b that holds the data to be distributed, the data is directly transmitted to each of the wireless terminal 101a and the wireless terminals 101c to 101f. Specifically, the data is sent from the wireless terminal 101b to the wireless terminal 101a via the access point 103a. The data is sent from the wireless terminal 101b to the wireless terminal 101c via the access point 103a. The data is sent from the wireless terminal 101b to the wireless terminal 101d via the access point 103a and the access point 103b. The data is sent from the wireless terminal 101b to the wireless terminal 101e via the access point 103a and the access point 103b. The data is sent from the wireless terminal 101b to the wireless terminal 101f via the access point 103a and the access point 103b.

Here, in a wireless section between the wireless terminal 101b and the access point 103a, uplink data transmission is performed five times. Accordingly, if the throughput in the wireless section between the wireless terminal 101b and the access point 103a is small, a delay in data transmission is likely to occur.

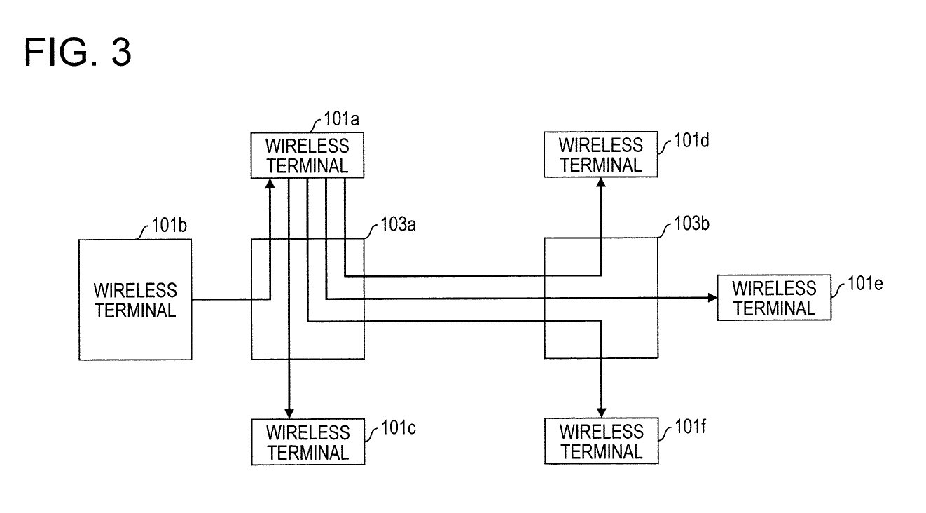

In the present embodiment, a wireless terminal 101 other than the wireless terminal 101 as the transmission origin may perform part of the simultaneous distribution by proxy. In the example illustrated in FIG. 3, the wireless terminal 101a performs part of the simultaneous distribution by proxy. That is, from the wireless terminal 101a that receives the distributed data, the data is re-transmitted to each of the wireless terminals 101c to 101f.

Specifically, first, the data is sent from the wireless terminal 101b to the wireless terminal 101a via the access point 103a. Then, the data is sent from the wireless terminal 101a to the wireless terminal 101c via the access point 103a. The data is sent from the wireless terminal 101a to the wireless terminal 101d via the access point 103a and the access point 103b. The data is sent from the wireless terminal 101a to the wireless terminal 101e via the access point 103a and the access point 103b. The data is sent from the wireless terminal 101a to the wireless terminal 101f via the access point 103a and the access point 103b.

Here, in a wireless section between the wireless terminal 101a and the access point 103a, downlink data transmission is performed once, and then uplink data transmission is performed four times. If the throughput in the wireless section between the wireless terminal 101a and the access point 103a is large, a delay in data transmission hardly occurs.

In the wireless section between the wireless terminal 101b and the access point 103a, data transmission is performed once. Thus, even if, for example, the throughput in the relevant section is small, a delay in data transmission hardly occurs.

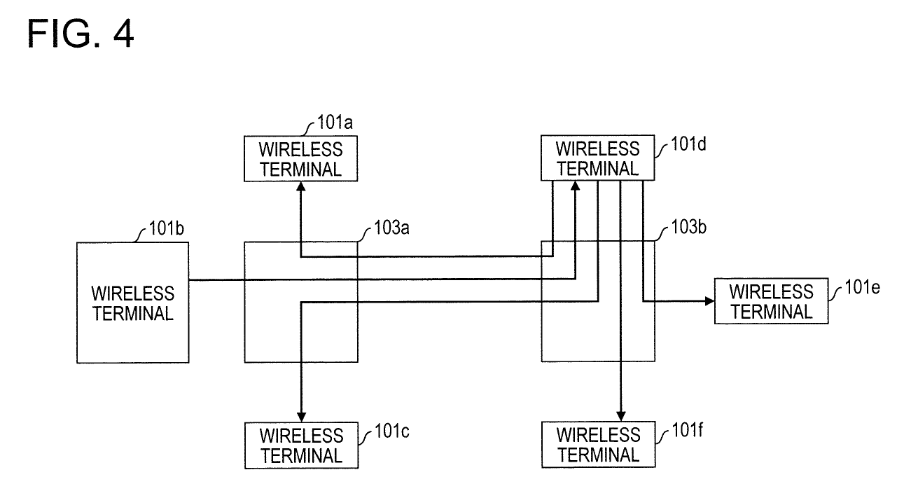

In addition to the above-described example, a wireless terminal coupled to an access point 103 other than the access point 103 to which the wireless terminal 101 as the transmission origin is coupled may perform part of the simultaneous distribution by proxy. In the example illustrated in FIG. 4, the wireless terminal 101d performs part of the simultaneous distribution by proxy. That is, from the wireless terminal 101d which receives the distributed data, the data is re-transmitted to each of the wireless terminal 101a, the wireless terminal 101c, the wireless terminal 101e, and the wireless terminal 101f.

Specifically, first, the data is sent from the wireless terminal 101b to the wireless terminal 101d via the access point 103a and the access point 103b. Then, the data is sent from the wireless terminal 101d to the wireless terminal 101a via the access point 103b and the access point 103a. The data is sent from the wireless terminal 101d to the wireless terminal 101c via the access point 103b and the access point 103a. The data is sent from the wireless terminal 101d to the wireless terminal 101e via the access point 103b. The data is sent from the wireless terminal 101d to the wireless terminal 101f via the access point 103b.

Here, in a wireless section between the wireless terminal 101d and the access point 103b, downlink data transmission is performed once, and then uplink data transmission is performed four times. If the throughput in the wireless section between the wireless terminal 101d and the access point 103b is large, a delay in data transmission hardly occurs.

Similarly to FIG. 3, since data transmission in the wireless section between the wireless terminal 101b and the access point 103a is performed once, a delay in data transmission hardly occurs.

According to the present embodiment, when the throughput in the wireless section of the wireless terminal 101 as the transmission origin is small, among other wireless terminals 101, a wireless terminal 101 having a large throughput in the wireless section is caused to perform part of the simultaneous distribution by proxy. For this purpose, the wireless terminal 101 as the transmission origin collects throughput in the wireless section of each of the wireless terminals 101, and selects a wireless terminal 101 having a large throughput. Then, the wireless terminal 101 as the transmission origin requests the selected wireless terminal 101 to perform the simultaneous distribution.

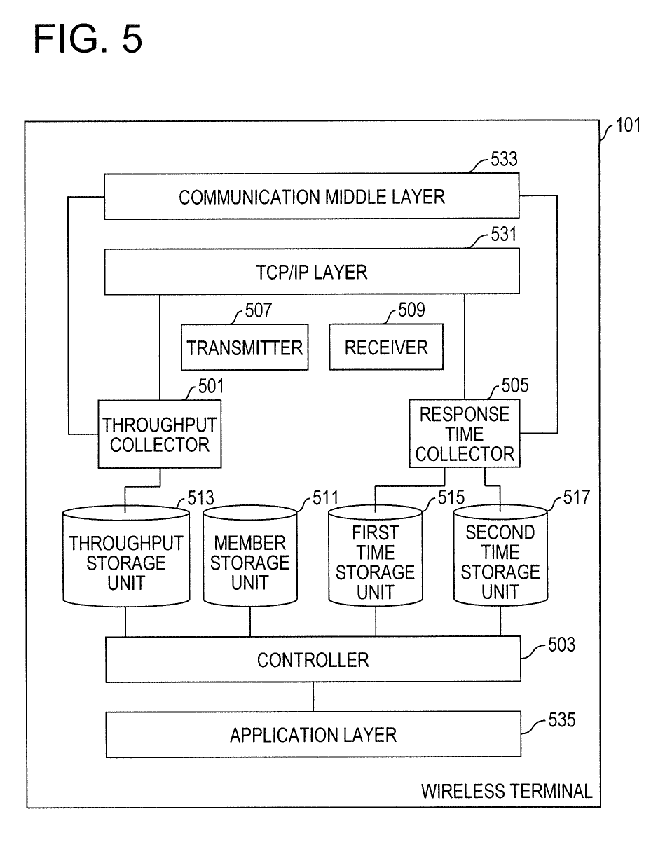

Hereinafter, an operation of a wireless terminal 101 will be described. FIG. 5 illustrates an exemplary functional configuration of a wireless terminal 101. The wireless terminal 101 includes a throughput collector 501, a controller 503, a response time collector 505, a transmitter 507, a receiver 509, a member storage unit 511, a throughput storage unit 513, a first time storage unit 515, and a second time storage unit 517.

The throughput collector 501 measures throughput in its own wireless section via, for example, a transmission control protocol (TCP)/Internet protocol (IP) layer 531 or a communication middle layer 533. The throughput collector 501 collects throughput in the wireless section of each of the wireless terminals 101. The controller 503 receives an instruction from an application layer 535 and controls a simultaneous distribution. The response time collector 505 collects response times from other wireless terminals 101 via the TCP/IP layer 531 or the communication middle layer 533, and determines a minimum value among the response times. The response time collector 505 also collects a minimum value of response times measured by each of the other wireless terminals 101. The transmitter 507 transmits various data. The receiver 509 receives various data. The response time collector 505 will be described in detail in a second embodiment.

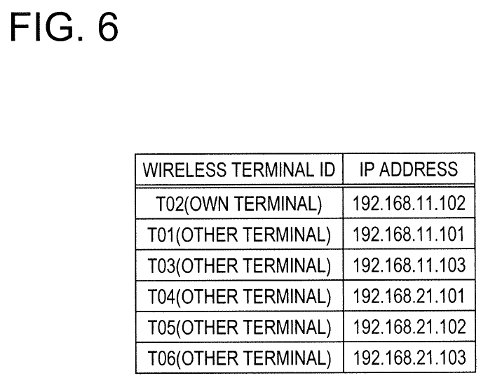

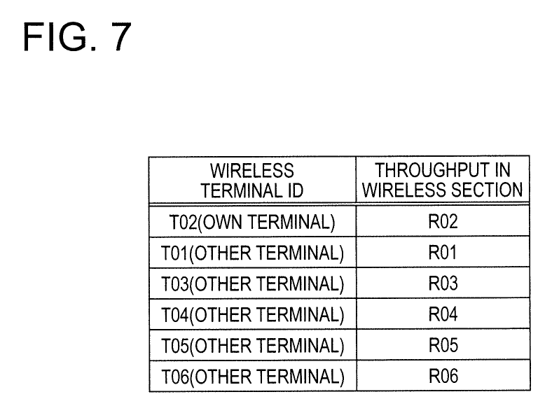

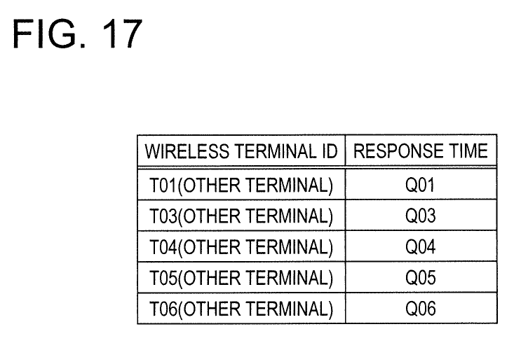

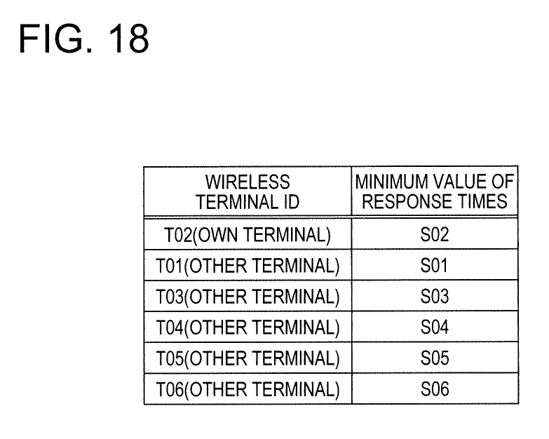

The member storage unit 511 stores therein a member table. The member table will be described later with reference to FIG. 6. The throughput storage unit 513 stores therein a throughput table. The throughput table will be described later with reference to FIG. 7. The first time storage unit 515 stores therein a first time table. The first time table will be described later with reference to FIG. 17. The second time storage unit 517 stores therein a second time table. The second time table will be described later with reference to FIG. 18.

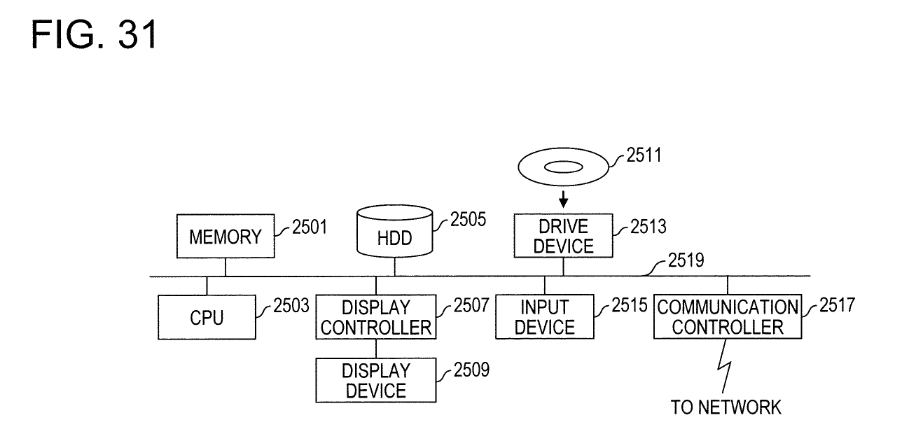

The throughput collector 501, the controller 503, the response time collector 505, the transmitter 507, and the receiver 509 described above are implemented using hardware resources (e.g., FIG. 31), and a program that causes a processor to execute the processes described below.

The member storage unit 511, the throughput storage unit 513, the first time storage unit 515, and the second time storage unit 517 described above are implemented using hardware resources (e.g., FIG. 31).

FIG. 6 illustrates an example of a member table. The member table is used to identify members belonging to a data sharing group. The member table in this example includes records corresponding to wireless terminals 101 as the members. The head record relates to a wireless terminal 101 that holds the relevant member table. The succeeding records relate to wireless terminals 101 as the other members.

Each record of the member table includes a field for storing a wireless terminal identifier (ID), and a field for storing an IP address. The wireless terminal ID identifies the wireless terminal 101 as the member. The IP address is an IP address of the wireless terminal 101.

The illustrated head record indicates that the wireless terminal 101 holding the member table is identified by an ID “T02”, and the IP address thereof is “192.168.11.102”.

The illustrated next record indicates that the wireless terminal 101 as another member is identified by an ID “T01”, and the IP address thereof is “192.168.11.101”. In the following description, it is assumed that member tables are held in the respective wireless terminals 101 in advance.

FIG. 7 illustrates an example of a throughput table. The throughput table in this example includes records corresponding to wireless terminals 101 as the above-mentioned members. Each record of the throughput table includes a field for storing a wireless terminal ID, and a field for storing throughput in a wireless section. The wireless terminal ID is the same as those in the case of the member table. The throughput in a wireless section is throughput between a wireless terminal 101 and an access point 103 coupled to the relevant wireless terminal 101.

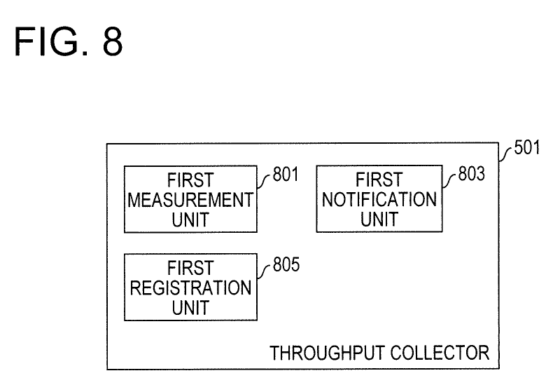

Subsequently, an operation of collecting throughput will be described. FIG. 8 illustrates an exemplary functional configuration of the throughput collector 501. The throughput collector 501 includes a first measurement unit 801, a first notification unit 803, and a first registration unit 805.

The first measurement unit 801 measures throughput in its own wireless section. The first notification unit 803 notifies the other member wireless terminals 101 of the throughput in its own wireless section. The first registration unit 805 registers throughput in the wireless section of each of the other member wireless terminals 101, in the throughput table.

The first measurement unit 801, the first notification unit 803, and the first registration unit 805 described above are implemented using hardware resources (e.g., FIG. 31), and a program that causes a processor to execute the processes described below.

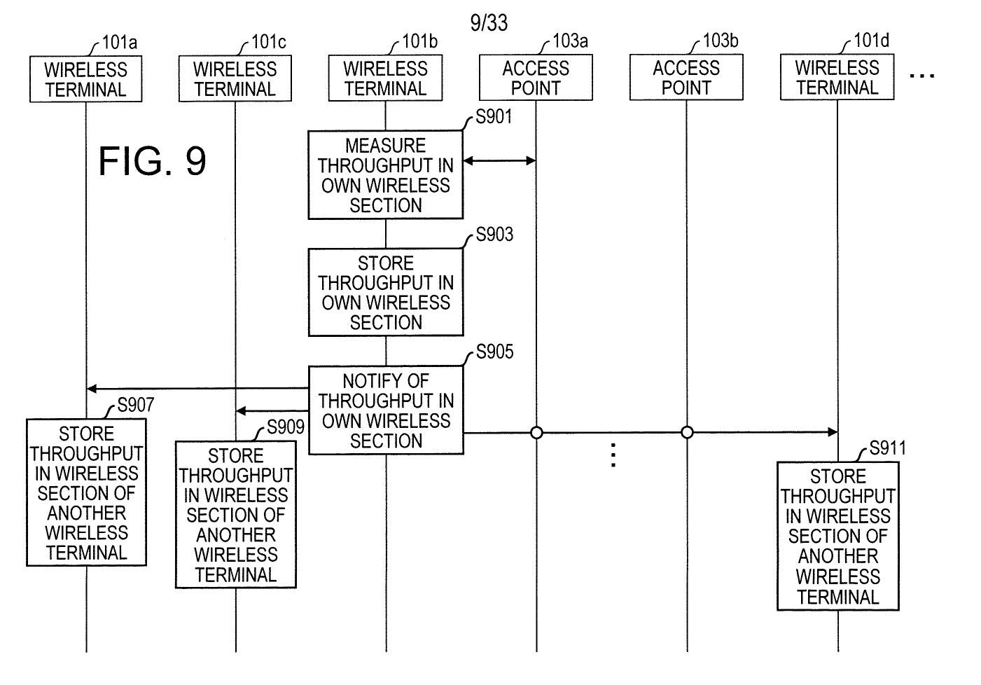

FIG. 9 illustrates an exemplary sequence of notifying of throughput in a wireless section. The sequence in this example focuses on throughput in the wireless section between the wireless terminal 101b and the access point 103a.

The first measurement unit 801 of the wireless terminal 101b measures throughput in its own wireless section, that is, throughput in the wireless section between the wireless terminal 101b and the access point 103a (S901). At this time, the first measurement unit 801 calculates the throughput on the basis of information (e.g., a size of transmitted data, a transmission time, and a reception time) acquired from the TCP/IP layer 531. The first measurement unit 801 may acquire the throughput from the TCP/IP layer 531. The first measurement unit 801 may calculate the throughput on the basis of information (e.g., a size of transmitted data, a transmission time, and a reception time) acquired from the communication middle layer 533. The first measurement unit 801 may acquire the throughput from the communication middle layer 533. Instead of the TCP/IP layer 531, a user datagram protocol (UDP)/IP layer may be used.

The first measurement unit 801 of the wireless terminal 101b stores the throughput in its own wireless section, in the throughput storage unit 513 (S903). The throughput in its own wireless section is stored in the head record of the throughput table. The first notification unit 803 of the wireless terminal 101b notifies other wireless terminals 101 of the throughput in its own wireless section via the transmitter 507 (S905). Notifications to the wireless terminals 101d to 101f are transmitted via the access point 103a and the access point 103b. In FIG. 9, circles are attached to the access points 103 through which the notifications are transmitted.

When the receiver 509 of the wireless terminal 101a receives the throughput in the wireless section of the wireless terminal 101b, the first registration unit 805 of the wireless terminal 101a stores the throughput in the wireless section of the wireless terminal 101b, in the throughput storage unit 513 (S907). Throughput in the wireless section in another wireless terminal 101 is stored in the record corresponding to other wireless terminal 101 in the throughput table.

Similarly, when the receiver 509 of the wireless terminal 101c receives the throughput in the wireless section of the wireless terminal 101b, the first registration unit 805 of the wireless terminal 101c stores the throughput in the wireless section of the wireless terminal 101b, in the throughput storage unit 513 (S909).

Similarly, when the receiver 509 of the wireless terminal 101d receives the throughput in the wireless section of the wireless terminal 101b, the first registration unit 805 of the wireless terminal 101d stores the throughput in the wireless section of the wireless terminal 101b, in the throughput storage unit 513 (S911). A notification to the wireless terminal 101e and a notification to the wireless terminal 101f are also processed similarly to the notification to the wireless terminal 101d.

The throughput in the wireless sections of the wireless terminal 101a, and the wireless terminals 101c to 101f are also similarly processed.

Described above, each wireless terminal 101 holds its own throughput and the throughput in other wireless terminals 101. This process is performed, for example, periodically, and each throughput is updated at any time.

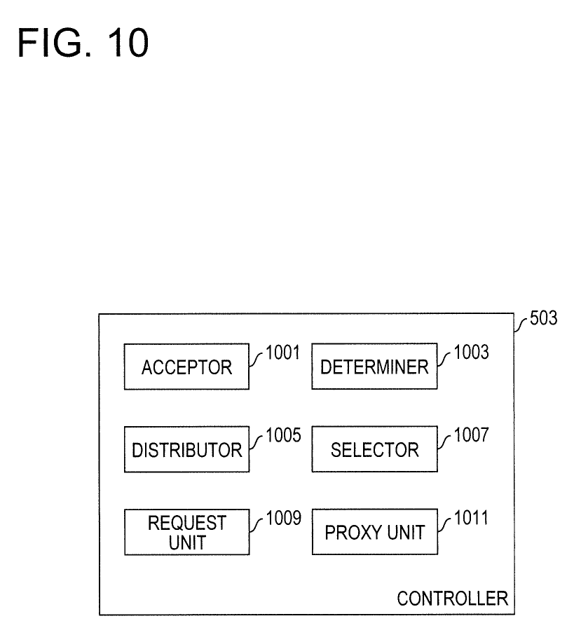

Subsequently, a control of a simultaneous distribution will be described. FIG. 10 illustrates an exemplary functional configuration of the controller 503. The controller 503 includes an acceptor 1001, a determiner 1003, a distributor 1005, a selector 1007, a request unit 1009, and a proxy unit 1011.

The acceptor 1001 accepts an instruction for a simultaneous distribution from the application layer 535. The determiner 1003 determines a state regarding the communication of the wireless terminal 101 itself. The distributor 1005 performs the simultaneous distribution. The selector 1007 selects a wireless terminal 101 as a request destination of the simultaneous distribution. The request unit 1009 requests the selected wireless terminal 101 to perform the simultaneous distribution. The proxy unit 1011 performs a simultaneous distribution by proxy, which is requested by another wireless terminal 101.

The acceptor 1001, the determiner 1003, the distributor 1005, the selector 1007, the request unit 1009, and the proxy unit 1011 described above are implemented using hardware resources (e.g., FIG. 31), and a program that causes a processor to execute the processes described below.

A main process performed by the controller 503 will be described. In the present embodiment, a main process (A) is performed. The main process (A) is based on the premise that each wireless terminal 101 holds throughput in the wireless section of the wireless terminal 101 itself and throughput in wireless sections of other wireless terminals 101.

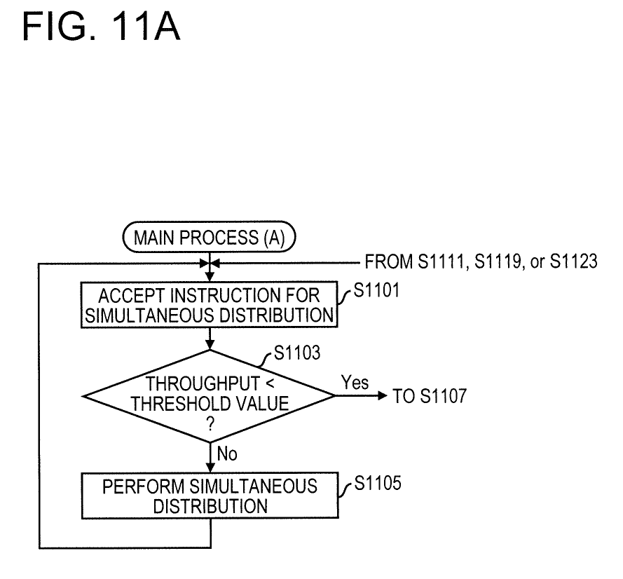

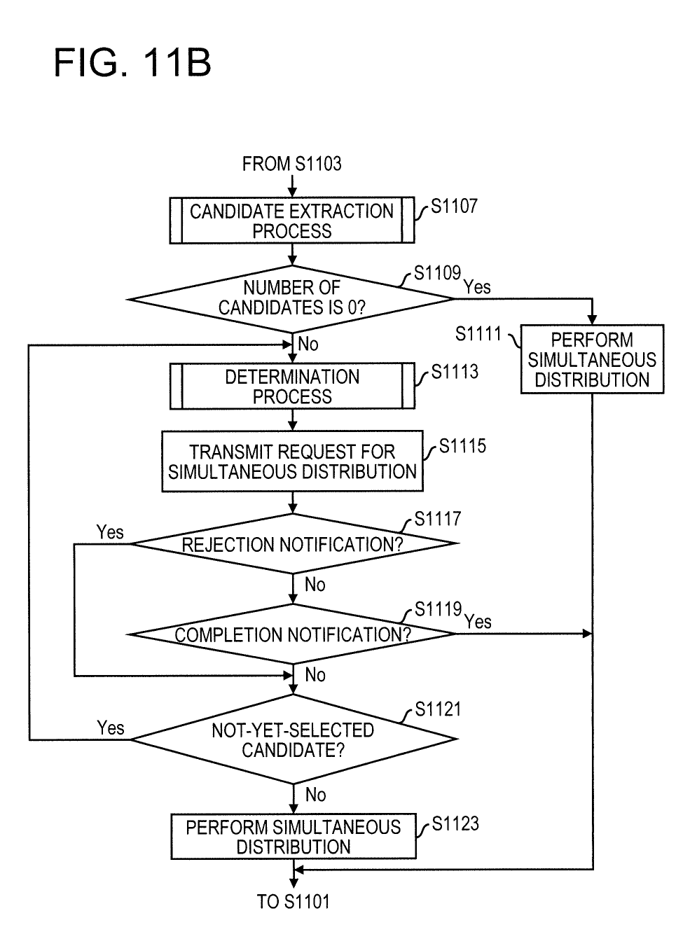

FIGS. 11A and 11B illustrate a flow of the main process (A). The acceptor 1001 accepts an instruction for a simultaneous distribution from the application layer 535 (S1101). In this example, it is assumed that data to be distributed and wireless terminal IDs (or IP addresses) identifying the respective plurality of destinations are passed. When the destinations are determined in advance, the destinations are not specified in the instruction.

The determiner 1003 determines whether the throughput in its own wireless section is lower than a threshold value (S1103). When it is determined that the throughput in its own wireless section is equal to or higher than the threshold value, that is, when it is determined that the communication state in its own wireless section is good, the distributor 1005 performs the simultaneous distribution (S1105). Specifically, the distributor 1005 transmits data to the plurality of destinations via the transmitter 507. Then, the process returns to S1101 to repeat the above-described processing.

When it is determined in S1103 that the throughput in its own wireless section is lower than the threshold value, that is, when it is determined that the communication state in its own wireless section is poor, the process proceeds to S1107 of FIG. 11B.

The selector 1007 performs a candidate extraction process (S1107). In the candidate extraction process, wireless terminals 101 to perform the simultaneous distribution by proxy are selected as candidates.

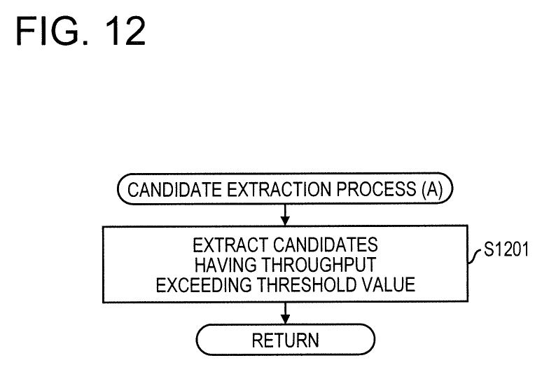

In the present embodiment, a candidate extraction process (A) is performed. FIG. 12 illustrates a flow of the candidate extraction process (A). The selector 1007 extracts, as candidates, wireless terminals 101 having throughput in the respective wireless sections, which is higher than a threshold value, among other wireless terminals 101 as the destinations (S1201). That is, wireless terminals 101 in a good communication state in the wireless section are selected.

In this example, the threshold value in S1201 is the same as the threshold value in S1103 of FIG. 11A. The threshold value in S1201 may be larger than the threshold value in S1103 of FIG. 11A. The threshold value in S1201 may be smaller than the threshold value in S1103 of FIG. 11A. The throughput in the wireless section of the wireless terminal 101 itself may be used as the threshold value in S1201. When the candidate extraction process (A) ends, the process returns to the main process (A) which has called the candidate extraction process (A).

Referring back to FIG. 11B, the selector 1007 determines whether the number of the extracted candidates is 0 (S1109). When it is determined that the number of the extracted candidates is 0, the distributor 1005 performs the simultaneous distribution (S1111). This is because it is thought that the efficiency of the simultaneous distribution is not increased even performed by proxy. Specifically, the distributor 1005 transmits data to the plurality of destinations via the transmitter 507. Then, the process returns to S1101 of FIG. 11A to repeat the above-described processing.

When it is determined that the number of the extracted candidates is one or more, the selector 1007 performs a determination process (S1113). In the determination process, a wireless terminal 101 to be requested to perform the simultaneous distribution is determined.

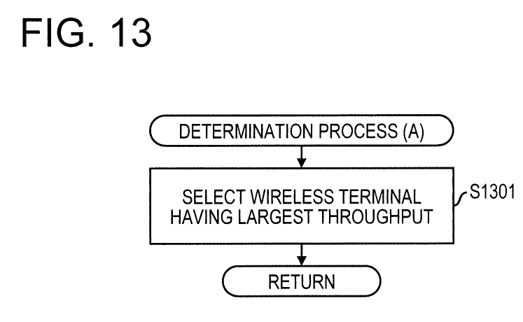

In the present embodiment, a determination process (A) is performed. FIG. 13 illustrates a flow of the determination process (A). The selector 1007 selects a wireless terminal 101 having the largest throughput among the candidate wireless terminals 101 (S1301). The selected wireless terminal 101 is a target to be requested to perform the simultaneous distribution. When the determination process (A) ends, the process returns to the main process (A) which has called the determination process (A).

Referring back to FIG. 11B, the request unit 1009 transmits the request for the simultaneous distribution, to the wireless terminal 101 determined in S1113 via the transmitter 507 (S1115). At this time, in addition to data to be distributed, wireless terminal IDs (or IP addresses) identifying the respective destinations of the simultaneous distribution are sent. The destinations of the simultaneous distribution correspond to the plurality of destinations instructed in S1101, except for the request destination of the simultaneous distribution.

Then, the request unit 1009 determines whether the receiver 509 receives a rejection notification (S1117). When it is determined that the rejection notification is not received, the request unit 1009 determines whether the receiver 509 receives a completion notification within a predetermined time (S1119).

When it is determined that the completion notification is received, that is, when it is determined that the simultaneous distribution performed by proxy is completed, the process returns to S1101 of FIG. 11A.

When it is determined in S1117 that the rejection notification is received, the process proceeds to S1121. When it is determined in S1119 that the completion notification is not received within the predetermined time, it is regarded that the simultaneous distribution is not performed by proxy, and the process proceeds to S1121.

The selector 1007 determines whether a not-yet-selected candidate remains (S1121). When it is determined that a not-yet-selected candidate remains, the process returns to S1113 to repeat the above-described processing.

When it is determined that no not-yet-selected candidate remains, the distributor 1005 performs the simultaneous distribution (S1123). That is, the distributor 1005 transmits data to the plurality of destinations via the transmitter 507. Then, the process returns to S1101 of FIG. 11A. The description of the main process is completed here.

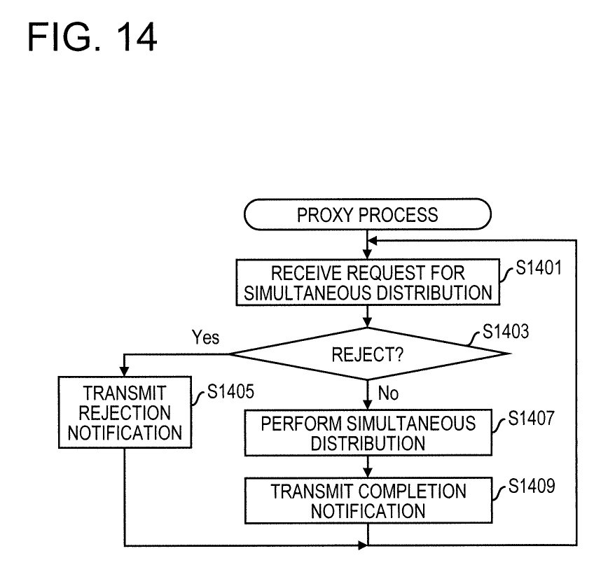

Subsequently, descriptions will be made of a proxy process in the case where simultaneous distribution by proxy is requested. FIG. 14 illustrates a flow of the proxy process. The receiver 509 stands by and receives a request for simultaneous distribution (S1401). When the request for simultaneous distribution is received, the proxy unit 1011 determines whether or not to reject the request (S1403). The proxy unit 1011 determines whether or not to reject the request on the basis of, for example, a processing load of the wireless terminal 101 itself.

When it is determined that the relevant request is to be rejected, the proxy unit 1011 transmits a rejection notification to the wireless terminal 101 as a request source via the transmitter 507 (S1405). Then, the process returns to S1401 to repeat the above-described processing.

When it is determined that the relevant request is not to be rejected, the distributor 1005 performs the simultaneous distribution (S1407). Specifically, the distributor 1005 transmits the data received in S1401 to the destinations as requested. When the simultaneous distribution ends, the proxy unit 1011 transmits a completion notification to the wireless terminal 101 as the request source via the transmitter 507 (S1409). Then, the process returns to S1401 to repeat the above-described processing.

Although an example where throughput is used as a communication quality of a wireless section has been described, other parameters related to a communication quality (e.g., an error rate or a delay time) may be used.

According to the present embodiment, even when a communication situation at a transmission origin is poor, a simultaneous distribution may be stably performed.

Since it is determined whether to request the simultaneous distribution on the basis of throughput in a wireless section, it is possible to cope with the case where wireless communication of the transmission origin is stagnant.

Since a request destination is selected on the basis of a communication situation of a destination, it is easy to avoid stagnation of a simultaneous distribution performed by proxy.

Particularly, since the request destination is selected based on throughput in a wireless section of the destination, it is easy to avoid the simultaneous distribution stagnation caused by a wireless communication situation of the request destination.

### Second Embodiment

In a second embodiment, descriptions will be made of an example where suitability as a distribution origin is determined based on a minimum value of response times from other wireless terminals 101, instead of throughput in a wireless section.

Therefore, in the present embodiment, the response time collector 505 collects response times from other wireless terminals 101, and determines a minimum value of the response times. The response time collector 505 also performs a process for sharing the minimum value of the response times with other wireless terminals 101.

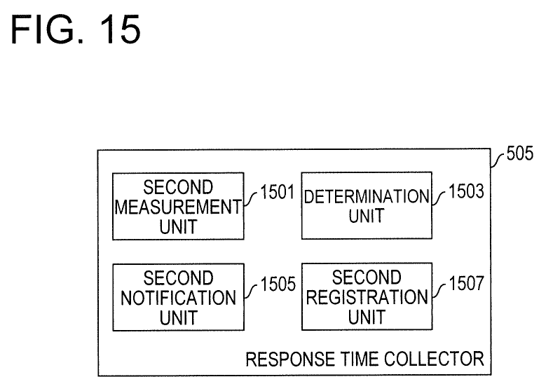

FIG. 15 illustrates an exemplary functional configuration of the response time collector 505. The response time collector 505 includes a second measurement unit 1501, a determination unit 1503, a second notification unit 1505, and a second registration unit 1507.

The second measurement unit 1501 measures a time until a response is received from other wireless terminals 101 since a request for reply is transmitted to the respective other wireless terminals 101, that is, a response time from the other wireless terminals 101. The determination unit 1503 determines a minimum value of the response times measured by itself. The second notification unit 1505 notifies other wireless terminals 101 of the determined minimum value of the response times. The second registration unit 1507 registers a minimum value of response times determined in the respective other wireless terminals 101 in a second time table.

The second measurement unit 1501, the determination unit 1503, the second notification unit 1505, and the second registration unit 1507 described above are implemented using hardware resources (e.g., FIG. 31), and a program that causes a processor to execute the process described below.

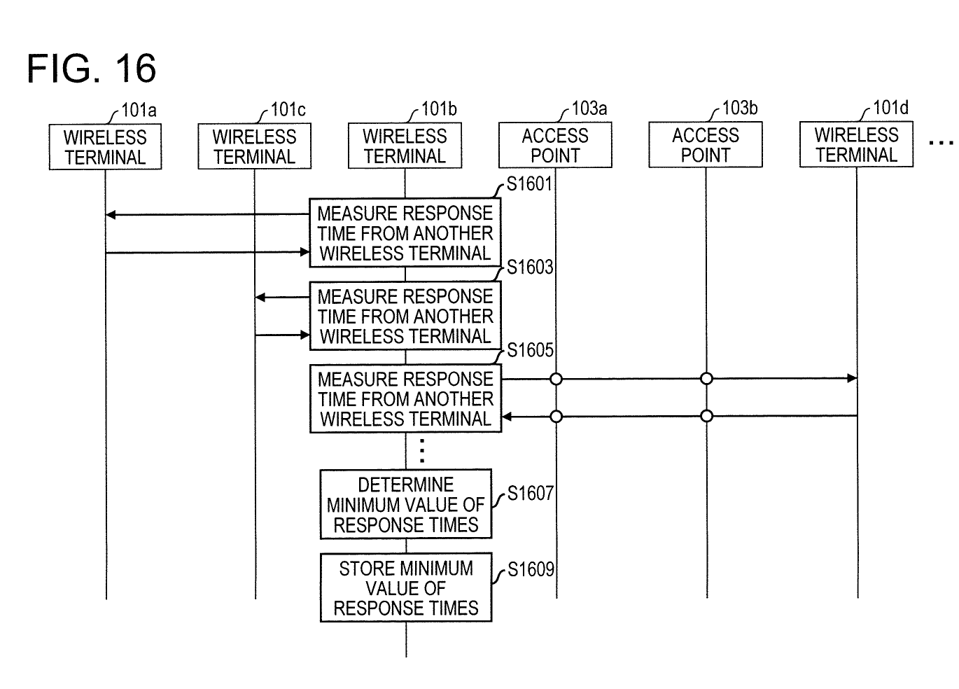

FIG. 16 illustrates an exemplary sequence of determining a minimum value of response times. The sequence in this example focuses on a response time measured by the wireless terminal 101b.

The second measurement unit 1501 measures a time until a response is acquired from the wireless terminal 101a via the TCP/IP layer 531 or the communication middle layer 533, that is, a response time (S1601). Similarly, the second measurement unit 1501 measures a time until a response is acquired from the wireless terminal 101c (S1603). Similarly, the second measurement unit 1501 measures a time until a response is acquired from the wireless terminal 101d (S1605). The second measurement unit 1501 also measures a time until a response is acquired from each of the wireless terminal 101e and the wireless terminal 101f. The response times are stored in the first time storage unit 515.

FIG. 17 illustrates an example of a first time table stored in the first time storage unit 515. In this example, the first time table includes records corresponding to the respective other wireless terminals 101. Each record of the first time table includes a field for storing a wireless terminal ID, and a field for storing a response time from another wireless terminal 101. The wireless terminal ID identifies a wireless terminal 101 as one of members other than the wireless terminal 101 itself that holds the relevant first time table. The response time from the relevant wireless terminal 101 is a response time measured by the wireless terminal 101 itself that holds the relevant first time table.

Referring back to FIG. 16, the determination unit 1503 determines a minimum value of the measured response times (S1607). The determination unit 1503 stores the minimum value of the response times measured by the wireless terminal 101 itself, in the second time storage unit 517 (S1609).

FIG. 18 illustrates an example of a second time table stored in the second time storage unit 517. In this example, the second time table includes records corresponding to the member wireless terminals 101. The head record relates to a wireless terminal 101 itself that holds the relevant second time table. The succeeding records relate to wireless terminals 101 as the other members.

Each record of the second time table includes a field for storing a wireless terminal ID, and a field for storing a minimum value of response times measured by the wireless terminal 101 of the relevant record. The wireless terminal ID identifies a wireless terminal 101 as a member. The minimum value of response times is notified from the wireless terminal 101 which measures the response times.

The minimum value of response times “S02” illustrated in the head record corresponds to the shortest response time among the response times “Q01”, “Q03”, “Q04”, “Q05”, and “Q06” illustrated in FIG. 17.

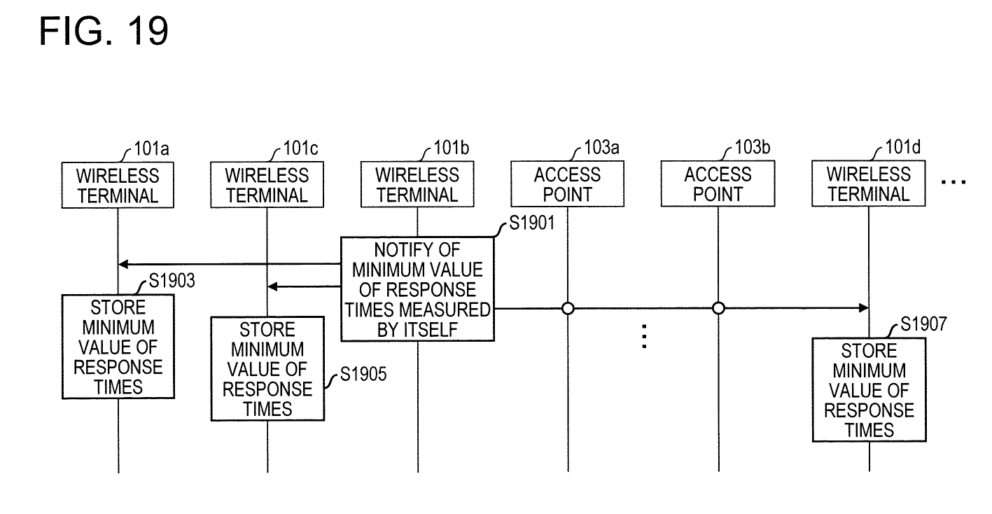

When the sequence illustrated in FIG. 16 is completed, the sequence shifts to a sequence illustrated in FIG. 19. FIG. 19 illustrates an exemplary sequence of notifying of a minimum value of response times. The second notification unit 1505 notifies other wireless terminals 101 of the minimum value of response times measured by the wireless terminal 101 itself via the transmitter 507 (S1901).

When the receiver 509 of the wireless terminal 101a receives the minimum value of response times in the wireless terminal 101b, the second registration unit 1507 of the wireless terminal 101a stores the minimum value of response times in the wireless terminal 101b, in the second time storage unit 517 (S1903). The minimum values of response times in other wireless terminals 101 are respectively stored in the records corresponding to the wireless terminals 101 in the second time table described above.

Similarly, when the receiver 509 of the wireless terminal 101c receives the minimum value of response times in the wireless terminal 101b, the second registration unit 1507 of the wireless terminal 101c stores the minimum value of response times in the wireless terminal 101b, in the second time storage unit 517 (S1905).

Similarly, when the receiver 509 of the wireless terminal 101d receives the minimum value of response times in the wireless terminal 101b, the second registration unit 1507 of the wireless terminal 101d stores the minimum value of response times in the wireless terminal 101b, in the second time storage unit 517 (S1907). A notification to the wireless terminal 101e and a notification to the wireless terminal 101f are also processed similarly to the notification to the wireless terminal 101d.

The minimum values of response times measured by the wireless terminal 101a and the wireless terminals 101c to 101f are also similarly processed.

As described above, each wireless terminal 101 holds a minimum value of response times measured by itself and minimum values of response times measured by other wireless terminals 101. This process is performed, for example, periodically, and the minimum values of response times are updated at any time.

Subsequently, a main process will be described. In the present embodiment, a main process (B) is performed. The main process (B) is based on the premise that a wireless terminal 101 holds a minimum value of response times measured by itself and minimum values of response times measured by other wireless terminals 101.

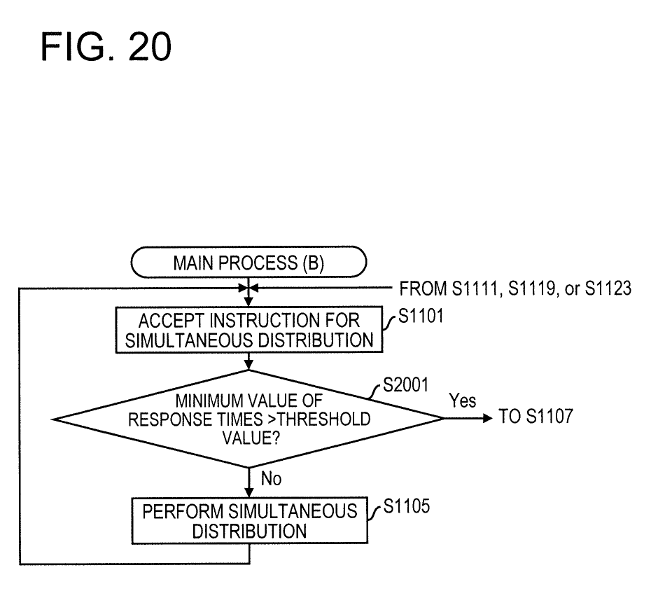

FIG. 20 illustrates a flow of the main process (B). The processing in S1101 is the same as that in the main process (A). The determiner 1003 determines whether a minimum value of response times measured by the wireless terminal 101 itself is higher than a threshold value (S2001).

When it is determined that the minimum value of the response times measured by the wireless terminal 101 itself is equal to or lower than the threshold value, that is, when it is estimated that a communication state of the wireless terminal 101 itself is good, the distributor 1005 performs a simultaneous distribution similarly to FIG. 11A (S1105).

When it is determined that the minimum value of the response times measured by the wireless terminal 101 itself is higher than the threshold value, the process proceeds to S1107 of FIG. 11B.

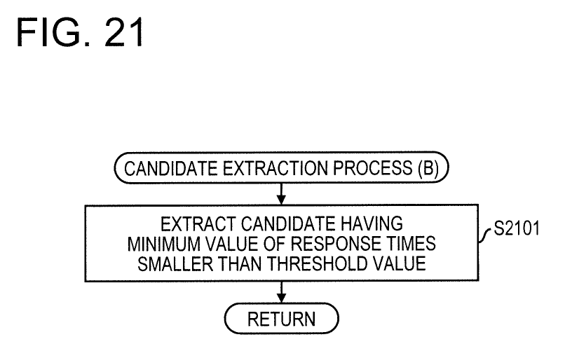

Hereinafter, the continuation of the main process (B) illustrated in FIG. 20 will be described with reference to FIG. 11B. In S1107, a candidate extraction process (B) is performed. FIG. 21 illustrates a flow of the candidate extraction process (B). The selector 1007 extracts a candidate having a minimum value of response times, which is smaller than the threshold value, among the other wireless terminals 101 (S2101). That is, a wireless terminal 101 estimated to have a good communication state is selected.

In this example, the threshold value in S2101 is the same as the threshold value in S2001 of FIG. 20. The threshold value in S2101 may be larger than the threshold value in S2001 of FIG. 20. The threshold value in S2101 may be smaller than the threshold value in S2001 of FIG. 20. The minimum value of response times measured by the wireless terminal 101 itself may be used as the threshold value in S2101. When the candidate extraction process (B) ends, the process returns to the main process (B) which has called the candidate extraction process (B).

Referring back to FIG. 11B, the processing in S1109 and S1111 is the same as that in the main process (A).

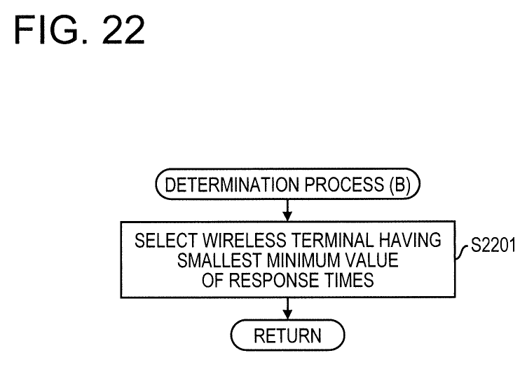

In S1113, a determination process (B) is performed. FIG. 22 illustrates a flow of the determination process (B). The selector 1007 selects a wireless terminal 101 having the smallest minimum value of response times among candidates on the basis of the second time table (S2201). The selected wireless terminal 101 is a target to be requested to perform the simultaneous distribution. When the determination process (B) ends, the process returns to the main process (B) which has called the determination process (B).

Referring back to FIG. 11B, the processing in S1115 to S1123 is the same as that in the main process (A).

Up to here, an example in which determination is made based on a minimum value of response times has been described. Since the minimum value of response times is likely to be a response time related to a transmission path not including a wired section, that is, a transmission path including only a wireless section, it is expected that an operation similar to the determination in the case of the first embodiment is performed. The determination may be made based on, for example, a maximum value of response times, an average value of response times, or a median value of response times, instead of the minimum value of response times.

When it is determined based on the minimum value of response times whether a simultaneous distribution performed by proxy is necessary, it is possible to cope with the case where a communication from a transmission origin to each destination is stagnant.

Since a wireless terminal 101 having a small minimum value of response times is selected as a request destination, it is easy to avoid stagnation of a simultaneous distribution, which is caused by a communication situation at the request destination.

The main process, the candidate extraction process, and the determination process may be combined as follows.

For example, in the main process (A), the candidate extraction process (A) and the determination process (B) may be performed. In the main process (A), the candidate extraction process (B) and the determination process (A) may be performed. In the main process (A), the candidate extraction process (B) and the determination process (B) may be performed.

For example, in the main process (B), the candidate extraction process (A) and the determination process (A) may be performed. In the main process (B), the candidate extraction process (A) and the determination process (B) may be performed. In the main process (B), the candidate extraction process (B) and the determination process (A) may be performed.

### Third Embodiment

In a third embodiment, descriptions will be made of an example where a wireless terminal 101 having a shorter response time to a reply request from a transmission origin is selected as a request destination from among the candidate wireless terminals 101.

Here, an example based on the second embodiment will be described. In the present embodiment, instead of the determination process (B) in the second embodiment, a determination process (C) is performed.

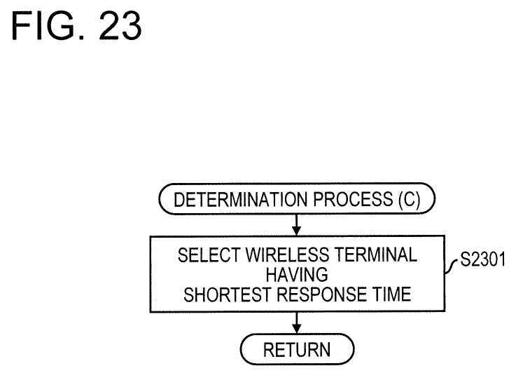

FIG. 23 illustrates a flow of the determination process (C). The selector 1007 selects a wireless terminal 101 having the shortest response time among the candidates on the basis of the first time table (S2301). The selected wireless terminal 101 is a target to be requested to perform the simultaneous distribution. When the determination process (C) ends, the process returns to the main process (B) which has called the determination process (C).

According to the present embodiment, since a situation of communication with the request destination is good, the request for a simultaneous distribution may be smoothly performed.

The main process, the candidate extraction process, and the determination process may be combined as follows.

For example, in the main process (A), the candidate extraction process (A) and the determination process (C) may be performed. In the main process (A), the candidate extraction process (B) and the determination process (C) may be performed.

For example, in the main process (B), the candidate extraction process (A) and the determination process (C) may be performed.

Examples in which each wireless terminal 101 is coupled to any one of two access points 103 has been described, but a method of coupling the wireless terminals 101 and the access points 103 to each other is not limited thereto.

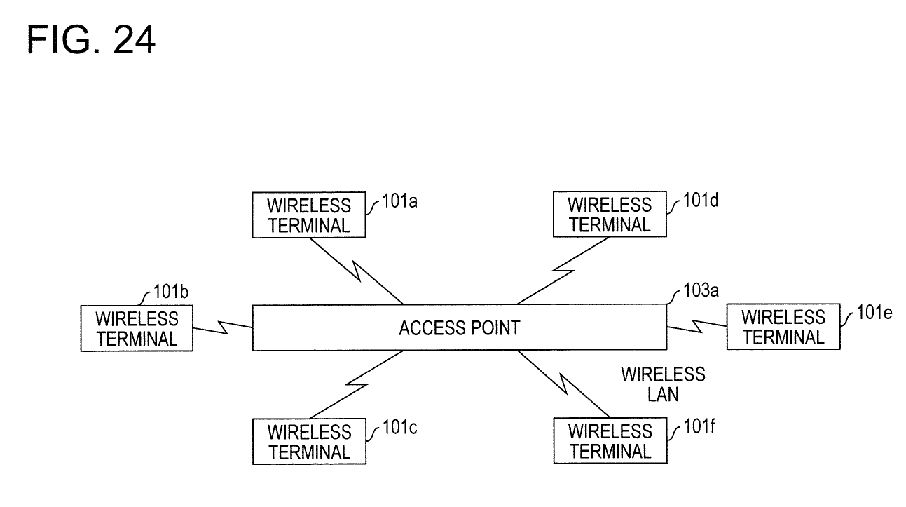

As illustrated in FIG. 24, the above-described process may be applied to a configuration in which each of the wireless terminals 101a to 101f is coupled to the same access point 103.

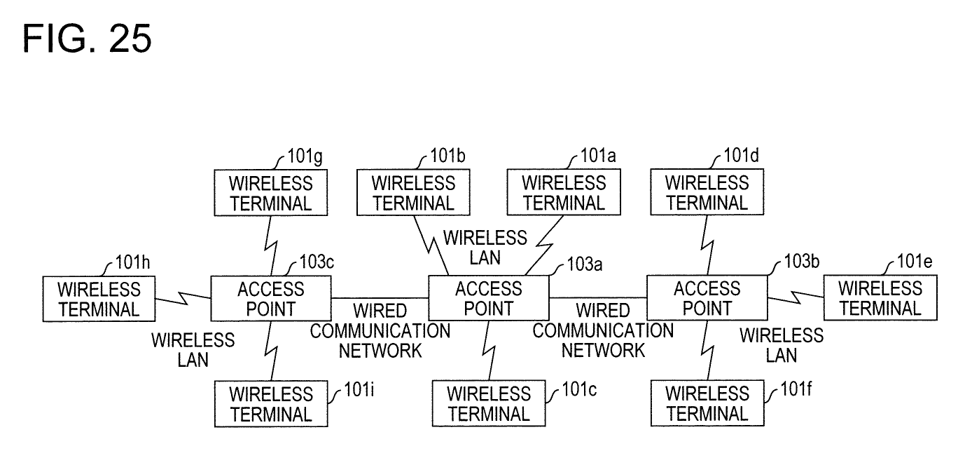

As illustrated in FIG. 25, the above-described process may be applied to a configuration in which each wireless terminal 101 is coupled to any one of three access points 103. In this example, the connection relationship between the wireless terminals 101a to 101f and the access point 103a and the access point 103b is the same as that in FIG. 1. In this example, an access point 103c is further provided. The access point 103c is coupled to the access point 103a via a wired communication network (e.g., a wired LAN or the Internet). Then, each of wireless terminals 101g to 101i is coupled to the access point 103c via a wireless LAN. The access point 103b and the access point 103c may be coupled to each other via a wired communication network (e.g., a wired LAN or the Internet). Also, the above-described process may be applied to a configuration in which each wireless terminal 101 is coupled to any one of four or more access points 103. The access points 103 may be coupled to each other by a wireless communication medium.

### Fourth Embodiment

In a fourth embodiment, descriptions will be made of an example where destination wireless terminals 101 are divided into a plurality of groups, and a simultaneous distribution within a group is performed for each group.

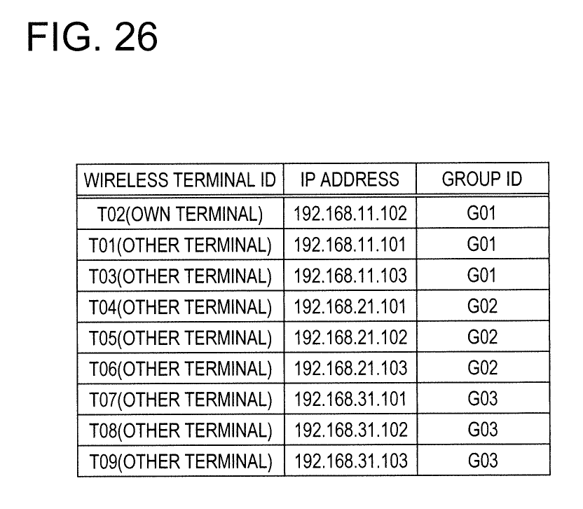

FIG. 26 illustrates an example of a member table in the fourth embodiment. Similarly to the member table illustrated in FIG. 6, the member table includes records corresponding to the member wireless terminals 101 of a group sharing data. The head record relates to a wireless terminal 101 itself that holds the relevant member table. The succeeding records relate to the other member wireless terminals 101.

Each record of the member table includes a field for storing a wireless terminal ID, a field for storing an IP address, and a field for storing a group ID. This example corresponds to a network configuration illustrated in FIG. 25. The wireless terminal IDs “T01” to “T09” correspond to wireless terminals 101a to 101i, respectively. The group ID identifies a group to which the relevant wireless terminal 101 belongs. The IP address includes a network address (e.g., “192.168.11”) and a host address (e.g., “101”), and IP addresses having the same network address may be set as one group.

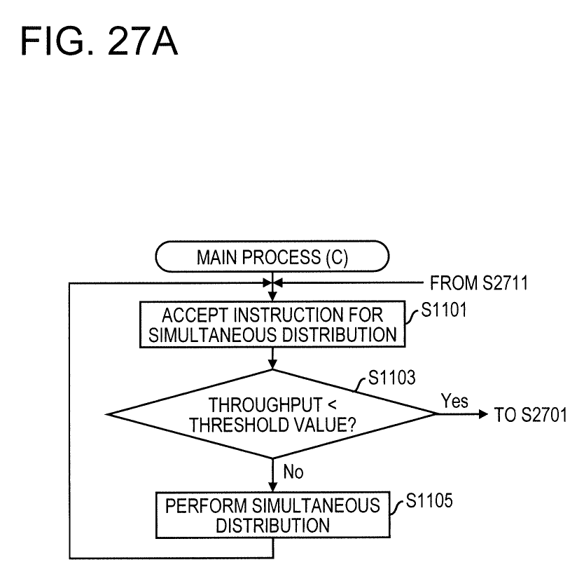

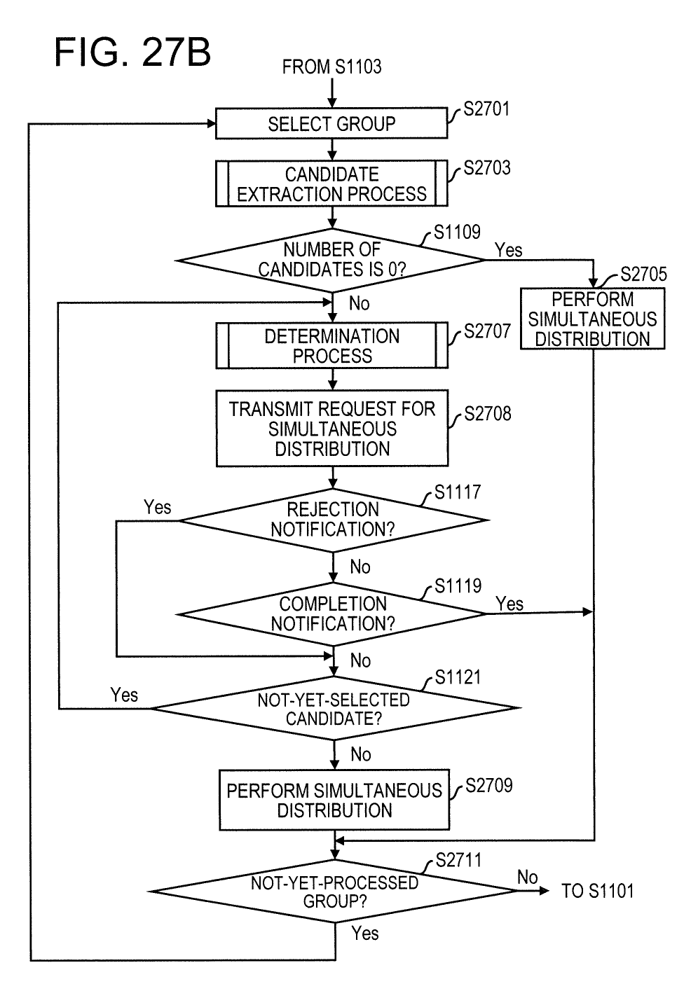

FIGS. 27A and 27B illustrate a flow of a main process (C). The processing in S1101 to S1105 is the same as that in the main process (A).

When it is determined in S1103 that the throughput in the wireless section of the relevant wireless terminal is lower than the threshold value, that is, when a communication state in the wireless section of the relevant wireless terminal is poor, the process proceeds to S2701 of FIG. 27B.

The selector 1007 selects one group on the basis of the member table (S2701). The order in which groups are selected is arbitrary.

When one group is selected, the selector 1007 performs a candidate extraction process (S2703). In the present embodiment, a candidate extraction process (C) is performed.

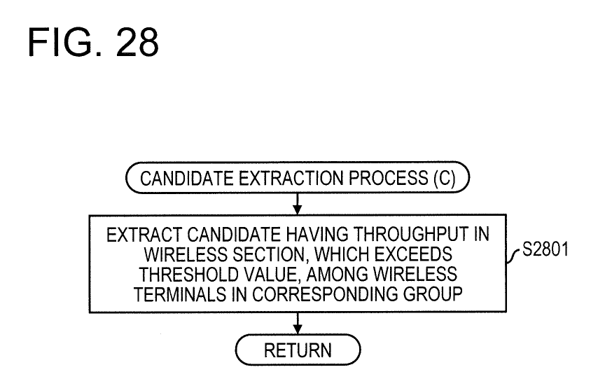

FIG. 28 illustrates a flow of the candidate extraction process (C). The selector 1007 extracts a candidate having throughput in a wireless section, which is higher than a threshold value, among wireless terminals 101 of the group selected in S2701 of FIG. 27B (S2801). That is, a wireless terminal 101 in a good communication state in a wireless section is selected.

In this example, the threshold value in S2801 is the same as the threshold value, for example, in S1103 of FIG. 27A. The threshold value in S2801 may be larger than the threshold value in S1103 of FIG. 27A. The threshold value in S2801 may be smaller than the threshold value in S1103 of FIG. 27A. The throughput in the wireless section of the relevant wireless terminal may be used as the threshold value in S2801. When the candidate extraction process (C) ends, the process returns to the main process (C) which has called the candidate extraction process (C).

Referring back to FIG. 27B, similarly to the main process (A), the selector 1007 determines whether the number of extracted candidates is 0 (S1109).

When it is determined that the number of the extracted candidates is 0, the distributor 1005 performs the simultaneous distribution in the group selected in S2701 (S2705). That is, the distributor 1005 transmits data to the wireless terminals 101 included in the relevant group among the plurality of destinations included in the instruction accepted in S1101 of FIG. 27A, via the transmitter 507. Then, the process proceeds to S2711.

When it is determined that the number of the extracted candidates is one or more, the selector 1007 performs a determination process (S2707). In the present embodiment, any one of the above-described determination processes (A) to (C) may be performed.

Then, the request unit 1009 transmits a request for the simultaneous distribution, to the wireless terminal 101 determined in S2707 via the transmitter 507 (S2708). Here, in addition to data to be distributed, wireless terminal IDs (or IP addresses) identifying destinations of the simultaneous distribution are sent. The destinations of the simultaneous distribution correspond to the wireless terminals 101 included in the relevant group among the plurality of destinations included in the instruction accepted in S1101 of FIG. 27A, except for the request destination wireless terminals 101 of the simultaneous distribution.

The processing in S1117 to S1121 is the same as that in the main process (A). When it is determined in S1121 that a not-yet-selected candidate remains, the process returns to S2707 to repeat the above-described processing. In S1119, when it is determined that the completion notification is received within a predetermined time, the process proceeds to S2711.

When it is determined in S1121 that no not-yet-selected candidate remains, the distributor 1005 performs the simultaneous distribution of the group selected in S2701 (S2709). That is, the distributor 1005 transmits data to the wireless terminals 101 included in the relevant group among the plurality of destinations included in the instruction accepted in S1101 of FIG. 27A, via the transmitter 507.

In S2711, the selector 1007 determines whether a not-yet-processed group is present. When it is determined that a not-yet-processed group is present, the process returns to S2701 to repeat the above-described processing. When it is determined that no not-yet-processed group is present, the process returns to S1101 of FIG. 27A.

According to the present embodiment, it is possible to distribute the processing load and the communication load for the simultaneous distribution.

### Fifth Embodiment

In the fourth embodiment, similarly to the first embodiment, descriptions have been made of an example in which when it is determined based on throughput in the wireless section that the wireless terminal itself has no suitability as a distribution origin, a request is made for each group. In a fifth embodiment, similarly to the second embodiment, descriptions will be made of an example in which when it is determined based on the minimum value of response times from other wireless terminals 101 that a wireless terminal itself has no suitability as a distribution origin, a request is made for each group.

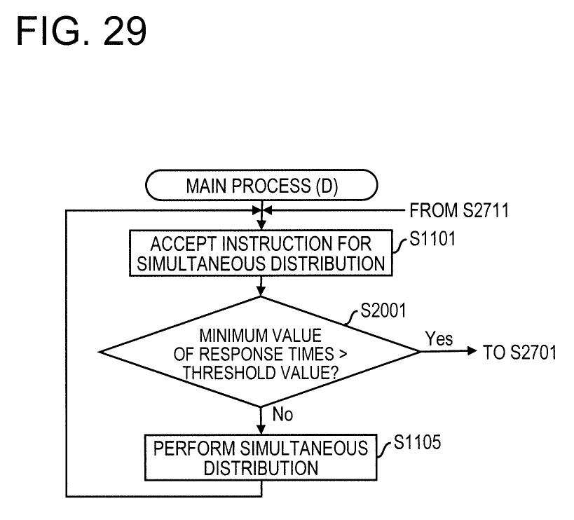

FIG. 29 illustrates a flow of a main process (D). The processing in S1101, S2001, and S1105 is the same as that in the main process (B).

In S2001, when it is determined that the minimum value of response times measured by the wireless terminal 101 itself is higher than a threshold value, the process proceeds to S2701 of FIG. 27B.

Hereinafter, the continuation of the main process (D) illustrated in FIG. 29 will be described with reference to FIG. 27B. Similarly to the fourth embodiment, the selector 1007 selects one group on the basis of the member table (S2701).

When one group is selected, the selector 1007 performs a candidate extraction process (S2703). In the present embodiment, a candidate extraction process (D) is performed.

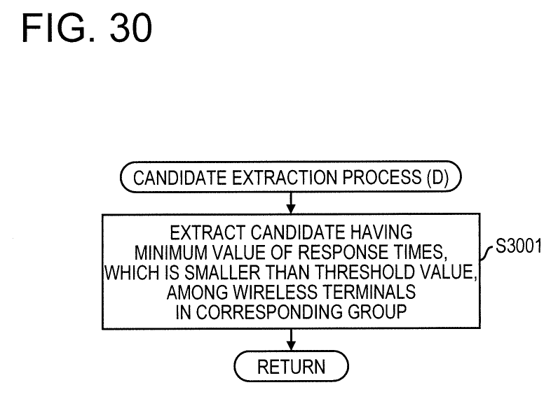

FIG. 30 illustrates a flow of the candidate extraction process (D). The selector 1007 extracts a candidate, which has a minimum value of response times, which is lower than the threshold value, among wireless terminals 101 in the group selected in S2701 of FIG. 27B (S3001). That is, a wireless terminal 101 estimated to have a good communication state is selected. When the candidate extraction process (D) ends, the process returns to the main process (D) which has called the candidate extraction process (D).

Referring back to FIG. 27B, the processing in S1109 and thereafter is the same as that in the fourth embodiment. In S2707, any one of the above-described determination processes (A) to (C) may be performed.

According to the present embodiment, it is possible to distribute the processing load and the communication load for the simultaneous distribution.

The main process, the candidate extraction process, and the determination process may be combined as follows.

For example, in the main process (D), the candidate extraction process (C) and the determination process (A) may be performed. In the main process (D), the candidate extraction process (C) and the determination process (B) may be performed. In the main process (D), the candidate extraction process (C) and the determination process (C) may be performed.

For example, in the main process (C), the candidate extraction process (D) and the determination process (A) may be performed. In the main process (C), the candidate extraction process (D) and the determination process (B) may be performed. In the main process (C), the candidate extraction process (D) and the determination process (C) may be performed.

Although the embodiments of the present disclosure have been described, the present disclosure is not limited thereto. For example, each functional configuration described above does not necessarily correspond to a program module configuration.

The configuration of each storage area described above is exemplary only, and it is not necessary to employ the above-described configuration. Also, in the processing flow, as long as the processing result is not changed, the order of the processing may be changed or a plurality of processing may be performed in parallel.

Each of the wireless terminals 101 described above is a computer device including a memory 2501, a central processing unit (CPU) 2503, a hard disk drive (HDD) 2505, a display controller 2507 coupled to a display device 2509, a drive device 2513 for a removable disk 2511, an input device 2515, and a communication controller 2517 for connecting to a network. These components are coupled via a bus 2519 as illustrated in FIG. 31. An operating system (OS) and an application program for executing processes in the embodiments are stored in the HDD 2505, and read from the HDD 2505 to the memory 2501 when executed by the CPU 2503. The CPU 2503 controls the display controller 2507, the communication controller 2517, and the drive device 2513 in accordance with the contents of the application program so that predetermined operations are performed. Data under processing is mainly stored in the memory 2501, but may be stored in the HDD 2505. In the embodiments disclosed herein, the application program for executing the above-described processes is stored in the computer-readable removable disk 2511 to be distributed, and installed from the drive device 2513 to the HDD 2505. The application program may be installed to the HDD 2505 via a network such as the Internet and the communication controller 2517. Such a computer device implements various functions described above as hardware such as the CPU 2503 and the memory 2501 described above and programs such as the OS and the application program are organically cooperated with each other.

In the embodiments, the communication controller 2517 performs a control of wireless communication. The communication controller 2517 performs a control of wireless communication by, for example, a wireless LAN method.

The above-described embodiments of the present disclosure may be summarized as follows.

An information processing apparatus according to the embodiments includes: (A) a determiner configured to determine whether a first communication situation in the information processing apparatus itself is worse than a reference when a simultaneous distribution is made to a plurality of distribution destinations; and (B) a request unit configured to request any one of the plurality of distribution destinations to perform the simultaneous distribution to all or some of the distribution destinations except for the relevant distribution destination when it is determined that the first communication situation is worse than the reference.

In this way, the simultaneous distribution may be stably performed.

The first communication situation may relate to the quality of wireless communication in the information processing apparatus.

In this way, it is possible to cope with the case where a wireless communication of a transmission origin is stagnant.

The first communication situation may be determined based on the communication quality between the information processing apparatus and each of the plurality of distribution destinations.

In this way, it is possible to cope with the case where a communication from the transmission origin to each distribution destination is stagnant.

A selector may be provided to select a request destination on the basis of a second communication situation in each of the plurality of distribution destinations.

In this way, the simultaneous distribution may be facilitated in the request destination.

The information processing apparatus may be coupled to a first node apparatus using a first wireless communication network. Each of the plurality of distribution destinations may be a first terminal coupled to the first node apparatus using the first wireless communication network, or a second terminal coupled, using a second wireless communication network, to a second node apparatus coupled to the first node apparatus. The second communication situation in each of the plurality of distribution destinations may relate to communication quality in a wireless section of the first wireless communication network or the second wireless communication network used by the relevant distribution destination.

In this way, it is easy to avoid the stagnation of a simultaneous distribution, which is caused by the situation of the wireless communication of the request destination.

The information processing apparatus may be coupled to a first node apparatus using a first wireless communication network. Each of the plurality of distribution destinations may be a first terminal coupled to the first node apparatus using the first wireless communication network, or a second terminal coupled, using a second wireless communication network, to a second node apparatus coupled to the first node apparatus. The second communication situation in each of the plurality of distribution destinations may be determined based on the communication quality between the relevant distribution destination and the first terminal and/or the second terminal other than the relevant distribution destination.

In this way, it is easy to avoid the stagnation of a simultaneous distribution, which is caused by a situation of a communication between the request destination and each distribution destination.

The selector may select a request destination on the basis of the communication quality between the information processing apparatus and each of the plurality of distribution destinations.

In this way, the request for the simultaneous distribution may be facilitated.

The selector may select a request destination in each group obtained by dividing the plurality of distribution destinations. Then, the request unit may request the request destination selected in each group to perform the simultaneous distribution to the distribution destinations included in the relevant group except for the request destination.

In this way, the processing load and the communication load for the simultaneous distribution may be distributed.

A program that causes a computer to execute the above-described processes in the information processing apparatus may be created. The program may be stored in, for example, a computer-readable storage medium or storage device such as a flexible disk, a compact disc read-only memory (CD-ROM), a magneto-optical disk, a semiconductor memory, and a hard disk. An intermediate processing result is generally temporarily stored in a storage device such as a main memory.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiments of the present disclosure has (have) been described in detail, it should be understood that the various changes, substitutions, and alterations could be made hereto without departing from the spirit and scope of the disclosure.

What is claimed is:

1. An information processing apparatus, comprising:
a memory; and
a processor coupled to the memory and the processor configured to:
determine, when a simultaneous distribution is made to a plurality of destinations, whether a first communication situation in the information processing apparatus is worse than a predetermined reference;
select a request destination from among the plurality of destinations upon determining that the first communication situation is worse than the predetermined reference; and
request the request destination to perform the simultaneous distribution to part of the plurality of destinations except for the request destination.

2. The information processing apparatus according to claim 1, wherein
the first communication situation relates to a quality of wireless communication in the information processing apparatus.

3. The information processing apparatus according to claim 1, wherein
the first communication situation is determined based on a quality of communication between the information processing apparatus and each of the plurality of destinations.

4. The information processing apparatus according to claim 2, wherein
the processor is configured to:
select the request destination on basis of a second communication situation in each of the plurality of destinations.

5. The information processing apparatus according to claim 4, wherein
the information processing apparatus is coupled to a first node apparatus using a first wireless communication network,
each of the plurality of destinations is a first terminal or a second terminal, the first terminal being coupled to the first node apparatus using the first wireless communication network, the second terminal being coupled to a second node apparatus using a second wireless communication network, the second node apparatus being coupled to the first node apparatus, and
the second communication situation relates to a quality of communication in a wireless section of the first wireless communication network or the second wireless communication network used by each of the plurality of destinations.

6. The information processing apparatus according to claim 4, wherein
the information processing apparatus is coupled to a first node apparatus using a first wireless communication network,
each of the plurality of destinations is a first terminal or a second terminal, the first terminal being coupled to the first node apparatus using the first wireless communication network, the second terminal being coupled to a second node apparatus using a second wireless communication network, the second node apparatus being coupled to the first node apparatus, and
the second communication situation relates to a quality of communication between each of the plurality of destinations and the respective destinations other than the relevant destination.

7. The information processing apparatus according to claim 1, wherein
the processor is configured to:
select the request destination on basis of a quality of communication between the information processing apparatus and each of the plurality of destinations.

8. The information processing apparatus according to claim 1, wherein
the plurality of destinations are divided into groups, and
the processor is configured to:
select the request destination for each of the groups; and
request the request destination to perform the simultaneous distribution to the destinations included in the relevant group except for the request destination.

9. An information processing method, comprising:
determining by a computer, when a simultaneous distribution is made to a plurality of destinations, whether a first communication situation in the computer is worse than a predetermined reference;
selecting a request destination from among the plurality of destinations upon determining that the first communication situation is worse than the predetermined reference; and
requesting the request destination to perform the simultaneous distribution to part of the plurality of destinations except for the request destination.

10. A non-transitory computer-readable recording medium having stored therein a program that causes a computer to execute a process, the process comprising:
determining, when a simultaneous distribution is made to a plurality of destinations, whether a first communication situation in the computer is worse than a predetermined reference;
selecting a request destination from among the plurality of destinations upon determining that the first communication situation is worse than the predetermined reference; and
requesting the request destination to perform the simultaneous distribution to part of the plurality of destinations except for the request destination.
